(19) United States
(12) Patent Application Publication
(10) Pub. No.: US 2007/0184396 A1
(43) Pub. Date: Aug. 9, 2007

(54) Method and system for process gas entrainment and mixing in a kiln system

(75) Inventor: Thomas McQuiggin Lowes, Kent (GB)

Correspondence Address: CHAPMAN AND CUTLER, 111 WEST MONROE STREET, CHICAGO, IL, 60603, US

(73) Assignee: Holcim Ltd., Jona (CH)

(21) Appl. No.: 10/563,233

(22) PCT Filed: Jul. 5, 2004
(86) PCT No.: PCT/IB04/02209

§ 371 Date: Jun. 9, 2006

(30) Foreign Application Priority Data
Jul. 4, 2003 (CA) 2434380
Oct. 21, 2003 (CA) 2445818

(51) Int. Cl. F27B 15/00

(52) U.S. Cl. 432/58

(57) ABSTRACT

A method and system for mixing process gas flow by adding or injecting suitably-directed high momentum turbulent gas into dust-laden stratified process gas flow at approximately 850 to 1400° C. to entrain the process gas flow such that stratification is reduced and mixing of both gases and suspended solids is improved. The jet entrainment of the process gas flow by appropriate injection of gas serves to enhance the contact of reacting materials, such as residual fuel and available oxygen, and further serves to improve the completion of reactions, such as combustion of the fuel and the transfer of heat to the raw material/kiln feed.

### FIELD OF THE INVENTION

The present invention relates to a method and system for process gas entrainment and mixing in a kiln system. More particularly, it relates to a method and system in which a process gas flow is entrained by injected gas causing mixing of the process gas flow and facilitating the combustion and removal of chemical species present in the process gas flow during combustion in a kiln system.

### BACKGROUND OF THE INVENTION

Kiln systems are known for processing cement clinker and various metallic and non-metallic minerals such as iron ore and lime. In this application, the text focuses on kiln systems for producing cement clinker, however, it will be understood by one of skill in the art that the concepts presented may have application in other types of kiln systems.

Cement clinker is the material that, when finely powdered forms cement, which is mixed with water and inert materials to form concrete and mortar. Cement clinker is conventionally produced by heating raw materials to very high temperatures in a kiln system. There are various types of kiln systems known in the art, including wet and dry “long” kiln systems and various types of preheater kiln systems. The following discussion will focus on preheater kiln systems however, similar processes occur in and similar difficulties may also arise in long kiln systems.

A conventional preheater kiln system used for the production of cement clinker generally consists of two sections, the preheater section and the kiln section. The preheating section consists of a gas riser duct and a series of cyclones, typically four or more in number mounted in a vertical structure, wherein the last cyclone in the series feeds into the kiln section via a feed chute.

The kiln section includes an inclined rotary kiln, which provides primary heating for the kiln system. The inclined rotary kiln includes a fuel inlet and flame at its lower end for heating the kiln. In some preheater kiln systems there may also be a secondary firing system in the gas riser duct or a precalciner (which is also sometimes referred to as a calciner), provided to calcine the majority of the raw material prior to entry to the kiln section. The precalciner may be provided between the preheating section and the kiln section but may also be a part of the preheater section.

For convenience, it is common practice to use a pair of cyclones in parallel at the uppermost stage of the preheater, and for high-throughput systems, a single kiln may have a complete set of “twin” preheater cyclones in series, with one or both of these “preheater strings” provided with a precalciner furnace or secondary firing system(s).

In a preheater kiln system, a mix of powdered raw material having the appropriate chemical composition (“raw meal”) is fed into the uppermost cyclone. The raw meal used in the production of clinker in a conventional kiln system is conventionally prepared from natural quarried products that are principally comprised of limestone (a source of calcium carbonate), which is calcined to lime during heat treatment, with liberation of carbon dioxide via an endothermic reaction, and shale (a source of silicates, aluminates and iron oxide). When necessary, local reserves of raw materials are supplemented by corrective amounts of components such as sand (a source of silica), bauxite (a source of alumina), pyrites (a source of iron oxide) and/or limestone (often from higher purity reserves) to make up the raw meal. The raw material is finely ground and blended to form the raw meal before it is added to the uppermost cyclone.

The raw meal provides a basic chemical mixture that, when calcined and combined with ash from fossil or alternative fuels in the kiln system, allows for the formation—in an alumino-ferrite flux—of a blend of calcium silicates and aluminates (called “clinker”). This is finely ground with addition of a set-control agent such as gypsum to form Portland cement, and when mixed with water, the silicates and aluminates undergo hydration reactions (i.e. set and grow in strength to produce concrete or mortar).

When the raw meal is fed into the uppermost cyclone it is dispersed and pre-heated by a gas flow emanating from the next cyclone down in the series. Within each cyclone there is a vortex that disperses and collects the raw meal. The vortex facilitates the movement of the raw meal from the first cyclone to the second cyclone in the series. As the raw meal moves down the cyclones it heats up and may partly calcine and, if combustible material is present, some of it may combust, ultimately leaving a final mixture known as kiln feed. The vortex in each of the cyclones facilitates the movement of the raw meal down the series until it reaches the last cyclone. During the preheating stage, before the raw meal reaches the inclined rotary kiln, the temperature of the raw meal is raised to approximately 600 to 900 degrees Celsius (° C.).

Once the raw meal passes through the last cyclone, it reaches the kiln hearth and (now referred to as “kiln feed”) moves into the upper end of the inclined rotary kiln via a feed chute. Upon entering the inclined rotary kiln, the kiln feed may also be referred to as hot meal. The hot meal progresses toward the lower end of the inclined rotary kiln in counter current to the gaseous products produced during fuel combustion at the lower end of the inclined rotary kiln.

As described above, the inclined rotary kiln has a flame at the lower end of the incline (the “flame zone”), which heats the contents of the rotary kiln. The temperature of the hot meal is raised to approximately 1450° C. before exiting the lower end of the rotary kiln. At this temperature the hot meal reaches a semi-molten state in which chemical reactions take place, forming clinker. The flame and gas temperatures at the lower end of the inclined rotary kiln must be considerably higher than 1450° C. to ensure that the hot meal reaches this temperature.

Once clinker is produced at the end of the inclined rotary kiln it flows into a clinker cooler where it is cooled by air. The hot air produced from the cooling of the clinker can then be reused to heat other sections of the kiln system, such as the preheater or the precalciner, in an effort to conserve energy. To move the hot air, the kiln system may be operated under negative pressure with exhaust gases being drawn through it under a draft induced by a fan. The fan may be located at or beyond the preheater exit.

In the kiln system, process gases travel up through the rotary kiln, gas riser duct and cyclones generally in counter current to the raw meal and may absorb many contaminants present. Prior to release to the atmosphere, the gases are typically dedusted to meet strict regulatory limits and if necessary are also cleansed of impurities such as NOx before release into the atmosphere.

A development in conventional preheater kiln systems is that fuel combustion may also take place in the secondary firing system (as described above), by supplying appropriately prepared fuel to the gas riser duct. This practice increases the throughput of a kiln system while having little effect on thermal efficiency. In addition, it also raises the degree of decarbonation (“calcining”) of limestone entering the inclined rotary kiln, in turn reducing the thermal load on the flame zone of the kiln and often reducing the volume of combustion gases flowing through the rotary kiln.

In a further development, secondary firing may be extended to a greater degree in kiln systems fitted with a precalciner. A precalciner is an additional combustion vessel or furnace that is located at or near the base of the preheater where it is fed with appropriate fuel and air, preferably preheated. Preheated air for the precalciner may be taken from the exhaust produced from the clinker cooler, as described above. The preheated air can be moved by by-passing the rotary kiln in an “air separate” system, where it is practical to do so. Alternatively, the air may be received from the rotary kiln in an “air through” variant.

Further advantages may accrue with the operation of a precalciner, similar to those described above for riser duct firing. One of the primary advantages is that the precalciner allows for a greater scope and selection of operating conditions, which in turn may allow for a reduction in the level of oxides of nitrogen (NOx) passing through the preheater to the atmosphere.

Another variation of a conventional kiln system includes the use of a grate pre-heater system, commonly referred to as a “Lepol grate”. Here, a finely ground raw meal mixture is formed into nodules/pellets by the addition of water to a rotating inclined dish. The pellets are then fed to the end of a traveling grate where they are swept by the kiln exhaust gases in order to be dried and preheated. Supplementary firing may be done in and after the gas riser duct connecting the upper end of the kiln to the hot end of the grate, known as “over grate firing”. This process has benefits and problems analogous to those that are described for the cyclone preheater systems, such as stratification of gases from combustion in the various parts of the kiln system.

Clinker production makes intensive use of natural resources, both in terms of energy and raw materials. Due to the natural origin of the raw meal/kiln feed and fuels used in a kiln system, minor amounts of other chemical species may also enter the kiln system. These other chemical species can enter in quantities that adversely influence conditions within the kiln system. Furthermore, kiln systems produce an exhaust gas stream that requires cleaning to ensure that any potentially harmful chemicals that may be produced during the process are reduced in concentration before the gas stream is released into the external environment and atmosphere.

Manufacturers are concerned with reducing their impact upon the environment. For example, use of prime reserves of raw materials and conventional fuels can be reduced by reducing the consumption of energy derived from fossil fuels. One way to reduce the use of prime reserves is by using alternative raw materials and/or alternative fuels, such as by-products of agricultural, process and commercial enterprises. These alternative substances can play a dual role in a kiln system. Some of the alternative substances used as partial replacements for raw materials may bring a fuel content with them and some alternative fuels may bring a significant content of ash, and as such play a dual role as both of these are required in a kiln system. A consequence of using alternative substances in lieu of traditional ones, however, can be that additional organic matter and carbon may be present for combustion in regions of the system other than the expected combustion in flame zones.

A drawback to the use of either a conventional or an alternative fuel (before processing “raw fuel”), is often the need for prior expensive and energy-intensive preparation, examples of such would be the fine grinding of solids or the atomization of liquids. Accordingly, there is a desire to use fuels effectively in the process and minimize the preparation required. Alternatively, there is a further trend underway to use fuels that are more difficult to burn (due to their hardness, moisture content or adhesiveness) as long as undue additional expenses are not incurred in preparing them, and provided their dispersal and maintenance in a suitably oxidizing gaseous medium (as required by their combustion characteristics) is maintained. By way of example, this trend can be seen in the techniques set out in various patents that deal with the introduction of used vehicle tires into the upper end of long kilns that are not generally equipped with preheaters. An example is U.S. Pat. No. 5,078,594, issued to Cadence Chemical Resources, Inc. and Ash Grove Cement Company.

The benefits of using alternative materials and fuels include reducing demands upon prime reserves and eliminating the problem of otherwise disposing of wastes and by-products and the attendant effects upon the environment.

Kiln systems are well suited for the use of various low-grade combustible coarse or lump fuels, because the ash can be assimilated within the clinker product. The reason for this is due to the fact that combustion occurs under controlled and high temperature conditions, with significant residence times for fuel particles at these temperatures.

Various difficulties arise in the operation of conventional kiln systems, including pre-heater kiln systems when using either traditional fossil fuels prepared according to conventional methods and/or alternative fuels prepared by less conventional means.

As a consequence, there may be limitations on the amount of one or more fuels, in a given state of preparation, that can be supplied to a precalciner, gas riser duct or upper end of a kiln while still maintaining suitable clinkering conditions at the lower/outlet end of the kiln system.

Conventional preheater kiln systems may have one or more of the following difficulties: (a) a build-up of solid material in the system resulting in either a partial or complete blockage; (b) an increased generation of one or more pollutants, such as NOx (or a limitation upon the degree of abatement possible within the process); (c) an increase in energy consumption per tonne of product; and/or (d) a reduced output rate.

Several of the above noted difficulties have the additional disadvantage of limiting the possibilities for reducing consumption of prime fossil fuels with a consequent accompanying limitation of the scope for reducing the generation and emission of greenhouse gases, such as carbon dioxide. Some of the difficulties can, in principle, be alleviated by more intensive pre-treatment and preparation of the fuel, in addition to using more complex procedures for its controlled delivery in the process. Implementing such solutions, however, is often not cost-effective.

Ideally, when more fuel energy is put into some part of the kiln system, such as a preheater gas riser, which is downstream with respect to the combustion products, of the main burning zone, the result should be an increase in solid throughput where there is either no change or only a small change in the temperature of the gases emerging from that part of the kiln system. Higher exit gas temperatures would suggest that the extra energy has not all been efficiently applied to heat the solid materials, but has instead been wasted in creating and heating the gases.

Techniques intended to promote the beneficial mixing of gases in kiln systems are known, however, the levels of momentum and swirl involved are typically not large enough to be completely effective aerodynamically. Accordingly, the techniques that can have the most advantageous effect on the flow of gases and on heat transfer to and from the fuel and feed particles are not present in the parts of the process where they can best contribute to solving the problems that arise with respect to completion of combustion and other chemical reactions in kiln systems.

As such, there is a need for an improved method and system for process gas mixing in kiln systems in order to improve the combustion and environmental efficiency of kiln systems.

### SUMMARY OF THE INVENTION

It is therefore an object of the present invention to provide an improved method and system for process gas mixing in kiln systems addressing at least some of the problems identified above.

In particular, an embodiment of the invention relates to a method and system for adding or injecting suitably-directed high momentum swirling turbulent gas to dust-laden stratified process gas at approximately 850 to 1400° C. to eliminate stratification and improve mixing of both process gases and suspended solids. The gas injection serves to enhance the contact of reacting materials, such as residual fuel and available oxygen, and further serves to improve the completion of reactions, such as combustion of the fuel and the transfer of heat to the raw meal/kiln feed/hot meal.

The projected benefits of the embodiments of the invention include increased fossil fuel substitution, lower carbon monoxide emissions lower emissions of oxides of nitrogen, ammonia and dioxins, higher levels of petroleum coke use and increased clinker output.

According to an embodiment of the invention, there is provided a system for mixing a process gas flow that is flowing through a housing of a kiln system, the system for mixing including at least one injector provided to the housing and a gas supply system connected to the at least one injector for supplying the gas to the injector at a predetermined pressure, wherein the injector and the predetermined pressure are arranged and selected to inject gas into the housing at sufficiently high momentum to produce a jet having the appropriate turbulent flow characteristics such that the process gas flow is entrained by the injected gas.

According to another embodiment of the invention, there is provided a system for mixing a process gas flow that is flowing through a housing along an axis of the housing. The system includes an injector provided in the housing and approximately on the axis and directed in the direction of process gas flow and a gas supply system connected to the injector for supplying gas to the injector at a predetermined pressure, wherein the injector and the predetermined pressure are arranged and selected to inject gas into the housing at sufficiently high momentum to produce a jet having the appropriate turbulent flow characteristics such that the process gas flow is entrained by the injected gases.

In either of the above embodiments, the injector may be provided with swirl vanes and, in a preferred case, swirl vanes having an angle of approximately 10 to 35 degrees. As an alternative or in combination with the swirl vanes, the injector may also be provided with flare diffusers and/or a bluff body to enhance the entrainment. Preferably, the flare diffusers are at approximately 5 to 20 degree half angles.

In these embodiments, the system for injecting gas is preferably arranged such that the process gas flow is substantially entrained before the injected gas flow is converted to plug flow along with the process gas flow or before the injected gas flow impinges upon the interior of the housing.

According to yet another embodiment of the invention, there is provided a system for mixing a process gas flow that is flowing through a housing along an axis of the housing, the system including a plurality of injectors provided to the housing and arranged at predetermined intervals around a cross section of the process gas flow and in communication with the interior of the housing, and a gas supply system for supplying gas to the injectors at a predetermined pressure, wherein the injectors are directed to inject gas to impinge tangentially on a circle centered on the axis of the process gas flow and covering at least approximately 5 to 15 percent of the cross sectional area of the process gas flow.

In particular, the plurality of injectors and the predetermined pressure are preferably arranged and selected to inject gas into the housing at sufficiently high momentum to produce a jet having the appropriate turbulent flow characteristics such that the process gas flow is entrained by the injected gas. In this case, the process gas flow is preferably substantially entrained before the injected gas flow is converted to plug flow along with the process gas flow or before the injected gas flow impinges upon the interior of the housing.

In a preferred case, the circle covers at least approximately 5 to 10 percent of the cross sectional area of the housing.

In the above embodiment, the injectors may be provided with swirl vanes and, in a preferred case, swirl vanes having an angle of approximately 10 to 35 degrees. As an alternative or in combination with the swirl vanes, the injectors may also be provided with flare diffusers and/or a bluff bodies to enhance the entrainment. Preferably, the flare diffusers are at approximately 5 to 20 degree half angles.

In a further preferred case, the plurality of injectors are directed at an angle of approximately 0 to 60 degrees in the direction of process gas flow. In this case, the plurality of injectors may be further preferably directed at an angle of approximately 25 to 40 degrees in the direction of process gas flow.

In another preferred case, the plurality of injectors comprise a first set of injectors and the system further includes a second set of injectors including a least one injector which is provided to the housing, arranged at a second cross section of the housing and is in communication with the interior of the housing and the at least one injector is directed to inject gas to impinge tangentially on a second circle centered on the axis of the housing that has a different diameter than the circle of the first set of injectors. It will be understood by one of skill in the art that injection gas may be supplied to the second set of injectors by the same gas supply system as the first set of injectors or by a second gas supply system. Preferably, the second circle has a larger diameter than the circle of the first set of injectors and the second cross section is spaced apart from the cross section of the first set of injectors in the direction of process gas flow.

In the above embodiments, the injected gas may be, for example, air or oxygenated air or the like and the injected gases may be preheated depending on the particular application of the system.

In the above embodiments, the system may be applied to a kiln system for preparing cement clinker and, in particular, may advantageously be applied in a region of the kiln system where the process gas temperature is between approximately 850 to 1400 degrees Celsius. Depending on the location of the system within the kiln system, for example, in a rotary kiln, the process gas temperature may preferably be between approximately 1000 to 1250 degrees Celsius, whereas in a region near a gas exit of a precalciner the gas temperature may be between approximately 900 to 1250 degrees Celsius. Further, when the system is applied such that said system will enhance the efficiency and completion of reactions with ammonia, the system is preferably applied in a region where the gas temperature is between approximately 850 to 1050 degrees Celsius.

It will be understood that the various embodiments of the system may be applied to a housing in one or more locations in a kiln system, for example, in the preheater section including the gas riser duct or precalciner, an exhaust gas by-pass system, or in the rotary kiln.

According to a further embodiment of the invention, there is provided a method for mixing a process gas flow of a kiln system including providing a source of injection gas at high pressure, and injecting the injection gas into the process gas flow at sufficiently high momentum to produce a jet having appropriate turbulent flow characteristics such that the process gas flow is entrained by the injected gas.

According to yet another embodiment of the invention, there is provided a method of mixing a process gas flow in a housing of a kiln system including providing a source of injection gas at high pressure, and injecting the injection gas into the housing such that the injection gas impinges tangentially on a circle centered on the axis of the process gas flow and covering at least approximately 5 to 15 percent of the cross sectional area of the process gas flow.

In a preferred case of the above two embodiments, the method may include imparting swirl to the injection gas as it enters the housing, for example, by using swirl vanes. Alternatively or in combination, the turbulent flow and entrainment may be enhanced by using flare diffusers and/or bluff bodies.

In a further preferred case, the total momentum of the injection gas during injection is approximately 50 to 150% of the momentum of the process gas flow.

In another preferred case, the injection gas is injected at or above approximately 150 meters/second.

Preferably, the Reynolds Number due to the mixing is increased approximately 2.5 times above that encountered in a typical process gas flow without the mixing and in a similar region in a kiln system. Further, the turbulent frequency due to the mixing is preferably increased to approximately 100 times above that encountered in a typical process gas flow without the mixing. Still further, it is preferable if the total momentum, turbulence and swirl of the injected gases are selected based on an aerodynamic calculation and/or mathematical modeling indicating that the injected gas would substantially entrain the whole of the process gas flow.

Other embodiments of the present invention include a rotary kiln, precalciner, exhaust gas by-pass system, gas riser duct, or other appropriate component of a kiln system having the system for mixing a process gas flow described above applied thereto.

The mixing provided by the gas injection results in improved combustion of lump solid fuels (such as tires, wood and plastics) to encourage full, controlled and non-polluting combustion with energy release. The mixing provided by the gas injection also improves gas-to-particle heat transfer and makes better use of available oxygen in a kiln system.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

The embodiments of the present invention shall be more clearly understood with reference to the following description of the preferred embodiments and to the drawings, in which:

FIG. 1 illustrates a preheater kiln system;

FIG. 2 illustrates swirling air systems (“SAS”) according to embodiments of the invention as applied to the preheater kiln system of FIG. 1;

FIG. 3 illustrates a swirl air system located in a precalciner between the tertiary air and feed entries according to an embodiment of the invention;

FIG. 4 illustrates a cross-sectional top view of the swirl air system with injectors located at the periphery of a rotating kiln section;

FIG. 5 illustrates a cross sectional view of a swirl air system located in a duct carrying dust-laden gases in a kiln system;

FIG. 6 illustrates a cross-sectional top view of a swirl air system comprising two concentric contra-rotating swirl vortices according to another embodiment of the invention;

FIG. 7 illustrates a cross-sectional side view of the swirl air system of FIG. 5;

FIG. 8 illustrates a cross-sectional top view of a portion of a precalciner, forming part of the preheater kiln system comprising two concentric contra-rotating swirl vortices according to another embodiment of the invention;

FIG. 9 illustrates a portion of a kiln system including the swirl air system of FIG. 8;

FIG. 10 illustrates an injector for the swirl air system of FIGS. 6 and 7;

FIG. 11 illustrates a portion of a kiln system including a swirl air system according to another embodiment of the invention;

FIG. 12 illustrates a preheater kiln system with secondary firing supplied to the gas riser duct illustrating including two possible locations for a swirl air system according to embodiments of the invention; and

FIG. 13 illustrates an air-separate calciner kiln system including two possible locations for a swirl air system according to embodiments of the invention.

### DETAILED DESCRIPTION

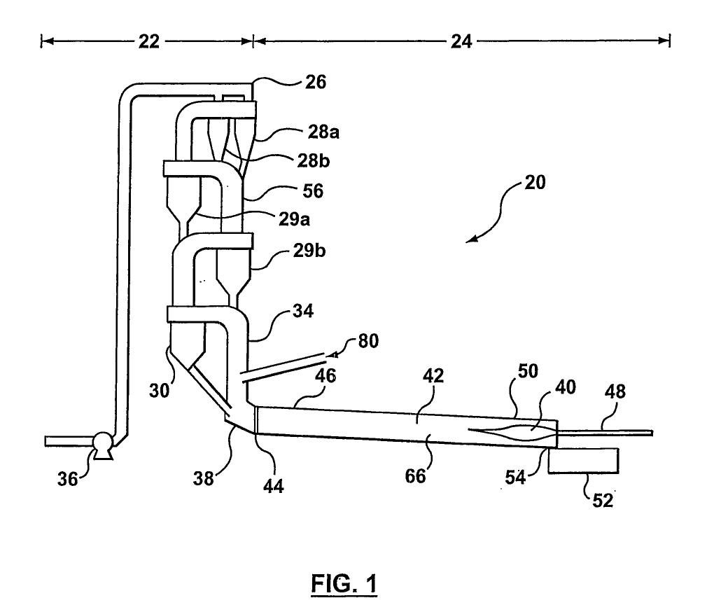

FIG. 1 illustrates a typical preheater kiln 20 having a preheater section 22 and a kiln section 24. The preheater section 22 includes a raw meal feeder 26, which feeds raw meal to the uppermost cyclones 28a, 28b of a series of inter-connected cyclones 29a, 29b and 30 through which the raw meal passes, a gas riser duct 34 which transports gases from the kiln section 24 to the cyclones, and a feed shelf (or kiln hearth) 38, which is connected to the lowermost cyclone(s) and also connects the preheater section 22 to the kiln section 24. The preheater section also includes one or more exhaust fans 36, which maintain appropriate pressure levels within the preheater section 22 and the rotary kiln 42. The rotary kiln section 24 includes an inclined rotary kiln 42, which is connected via a seal 44 to the kiln hearth 38 at an upper end 46 of the rotary kiln 42, and a fuel feed 48, which is provided at a lower end 50 of the rotary kiln 42 and provides fuel to provide a flame 40 to heat the interior of the rotary kiln 42. The kiln section 24 further includes a clinker cooler 52 which is connected via a seal 54 at the lower end 50 of the rotary kiln 42 near the fuel feed 48.

In operation, raw meal travels via the raw meal feeder 26 and enters into the first of the series of cyclones 28a and 28b. The raw meal is collected from the cyclones 28a and 28b by vortex action and travels into a duct 56 that is connected at the base of the cyclones 28a and 28b and then proceeds to enter a subsequent cyclone for redispersal into the gas stream. Eventually, the raw meal reaches the feed shelf 38 by the action of gravity and of the cyclones. At the same time that the raw meal is traveling through the preheater section 22, hot process gases from the kiln section 24 are rising through the gas riser duct 34 and through the cyclones in a generally reverse direction to the flow of raw meal. As such, the raw meal is heated as it is dispersed at each stage in the hot process gases coming from the cyclone below or via the gas riser duct 34 from the kiln section 24.

The hot raw meal on the feed shelf 38 (sometimes called “kiln feed”) then enters the kiln section 24 at the upper end 46 of the rotary kiln 42 where the kiln feed (now referred to as “hot meal”) continues to travel through the rotary kiln 42 by gravity and by the rotation of the rotary kiln 42, provoking mixture by sliding and tumbling. The hot meal continues to be heated throughout this process undergoing chemical reactions and forming clinker which eventually reaches the lower end 50 of the rotary kiln 42 where it is discharged into the clinker cooler 52 and cooled by a flow of air. This air flow is typically also used in other parts of the kiln system 20 to make use of the heat contained in the air following exposure to the clinker.

In this conventional preheater kiln system 20, additional fuel may also be added into the gas riser duct 34 or onto the feed shelf 38 of the preheater section 22 to provide further preheating of the raw meal prior to entry to the kiln section 24. Some fuel may also be added directly to the upper end 46 of the rotary kiln 42, e.g., used tyres.

In a kiln system, the burning of fuel and the chemical reactions occurring in the raw meal and hot meal result in the release of various chemical species into the process gas flow within the kiln system. Minor chemical species in a kiln system include compounds involving elements such as chlorine, sulphur, sodium, and potassium along with other elements within the same families. These are volatilized to a greater or lesser extent in the hotter regions of the kiln system and are carried in the process gas stream (sometimes also referred to as “process gas flow”) to colder regions where they condense and where they may form solutions with low melting points. The volatile species may then bind particles of solid feed material together and bind to the ductwork in the kiln system. This process can lead to partial and/or major blockages and as a result the kiln system will require cleaning or other intervention to maintain the proper output. In some situations a permanent set of air blasters can be installed to curtail the problem of blockage.

Having condensed, some of the volatile species that do not bind to the ductwork may travel down to the hot regions in the kiln system again and undergo the volatilization process again. This cyclical pattern may increase the concentrations of volatile species and aggravate the attendant problems.

The degree of volatilization of the compounds may be affected by the following: (1) the composition of the local gaseous atmosphere; (2) coming into contact with other chemical species in the bed of solids; (3) the temperature of the kiln system; and/or (4) the behavior upon condensation. For example, the decomposition of calcium sulphate is affected by concentrations of oxygen and carbon monoxide, by contact with solid carbon, and by temperature. The decomposition of calcium sulphate can have unfortunate consequences when the amount of sulphur entering the kiln system is greater than that which can enter into combination with available (non-halide combined) alkalis as alkali sulphates. When this happens, the excess sulphur tends to react to form calcium sulphate or calcium-potassium-sulphate otherwise known as “calcium langbeinite” which are liable to decompose and volatilize as local conditions vary. It is preferred that the sulphur leave the kiln with the clinker product in a stable chemically combined state, rather than decomposing, volatilizing and aggravating the recirculation, build-up and blockage phenomena.

Where extreme levels of circulating volatile compounds are encountered, it may be necessary to fit a by-pass system (“exhaust gas by-pass system”). This involves bleeding off a fraction of the rotary kiln exhaust from the gas riser duct via an off-take 80 of an exhaust gas by-pass system (not shown), quenching it to condense the volatiles and then removing them in a separate gas cleaning system that by-passes the preheater section.

Under certain conditions, halide species can be precursors in the formation of organic pollutants. Such conditions may exist when there are traces of organic impurities liberated from the raw meal and fuel being preheated. If suitable conditions of temperature, residence time and concentrations of chemical species exist, undesirable pollutants could then form and potentially be lost into the atmosphere once they condense onto dust or fume.

When oxidizing gases are not readily available, residual carbon (“char”) from traces of solid fuel within the raw material components or from coarse or lump fuel used in secondary or precalciner firing may sometimes persist throughout the pre-heater 22 and enter the inclined rotary kiln 42. The combustion of the residual char may then produce local reducing conditions for sulphates, aiding in volatilization and inhibiting condensation. To avoid this occurrence, attempts have sometimes been made to operate the kiln system with a higher level of excess air than otherwise required. The extra air aids in the combustion of char but leads to energy losses due to the related heating of the nitrogen in the extra air. This adversely affects the potential for clinker output where output is limited by the capacity of the induced draft exhaust fan 36. Inadequate combustion in a secondary firing system, such as precalciner 58, can also be a source of residual char passing into the rotary kiln 42.

Gas riser duct firing typically does not achieve useful gains in kiln throughput unless there is adequate heat transfer to the solid material being processed. In practice, this is seen for firing up to approximately 10 to 15% of fuel in kiln systems where kiln fuel replacement by good quality pulverized coal or oil at the secondary firing stage is used. When gas riser duct firing is implemented, higher excess air levels may need to be used to deal with other “difficult” low-volatile fuels such as petroleum coke (known as “petcoke”). The higher excess air levels here work to ensure complete combustion while keeping the probability of build-up acceptably low, but, as discussed above, bring a wastage of energy in heating the larger quantities of nitrogen in the extra air, as well as a reduction in kiln output rate.

In addition to the above, when lower grade fuels are used, extra air also needs to be passed through the kiln system resulting in a reduction of the temperature of the main flame 40. Accordingly, some or all of the extra energy will not be transferred to the raw material and raw fuel, which in turn results in a higher volume and temperature of exhaust gas being handled by the induced draft fan 36. If the draft fan 36 lacks the capacity to cope with the required new duty, it may further present a bottleneck in the kiln system 20 with respect to increased output rates. In this situation, transient carbon monoxide peaks may also be seen due to fuel quality or feed rate variations, resulting in a generally higher level of carbon monoxide emission from the system.

Carbon monoxide resulting from incomplete combustion will tend to rise toward the uppermost layers of gas within the rotary kiln 42, and it will not be positively mixed to react with the residual oxygen present. Conversely to carbon monoxide, carbon dioxide tends to be more highly concentrated near the solid bed 66 in the rotary kiln 42. Upon leaving the rotating kiln section 42, stratification of the gas may persist into lower regions of a preheater and riser duct firing system. The stratification does not help the rapid complete combustion of raw fuel and more particularly lump fuel added at the kiln feed shelf 38 or where it is allowed to fall onto the solid bed 66 at the upper end 46 of the rotary kiln 42, which is sometimes the practice for materials such as used tires.

Volatile chemicals liberated from a lump fuel as it ignites and burns enter the process gas flow and typically do not have the opportunity to react with all the traces of oxygen present until later mixed in the preheater section 22 or precalciner 58. This often occurs at lower temperatures and as a result, traces of volatile hydrocarbons can sometimes emerge into the atmosphere as undesired pollutants. The undesired pollutants may also be accompanied by higher than desired traces of unburned carbon monoxide. As described above, the conventional solution is to operate the kiln system at a higher level of excess air. This too has potential drawbacks that may limit the quantity of lump fuel that can be added at the upper end 46 of the rotary kiln 42. A possible solution is to enrich the oxygen content of the combustion air (rarely an economic proposition) and/or to undertake major and costly re-construction and enlargement of the kiln hearth 38 (if feasible) with an attendant loss of production during the modifications.

Another drawback in using lump fuels is that they can limit the potential use of high-sulphur fuels in the process, such as petroleum coke (“petcoke”), due to their influence on the decomposition, volatilization and deposition of sulphates. Such petcoke is often cheaper to obtain because petcoke cannot be used easily in some types of boilers and processes that do not inherently absorb the extra sulphur.

There is a need to achieve a more complete and uniform burnout of char, carbon monoxide and volatile material from “difficult” alternative fuels and to avoid operating kiln systems at unduly high and wasteful levels of excess air that may impair throughput. Here, “difficult” refers to the idea that virtually all alternative fuels have one problem or another, either due to residual carbon due to initial size or/and lack of volatile matter (tires, wood chips, petcoke), sudden volatile release due to either feeding (e.g., whole tires or bags/bales of commercial waste) or to high volatile contents (e.g. drill cuttings), or slow burnout (e.g., palm kernel shells, petcoke). Furthermore, it is possible that carbon dioxide concentrations in the boundary layer of process gas around the raw meal and fuel in the precalciner 58 may be high, as well as high carbon monoxide levels in the process gas surrounding the fuel particles, given the process gas flow and turbulence conditions that normally prevail. High carbon dioxide or carbon monoxide concentrations may require operating the precalciner 58 (See FIG. 13) at temperatures that are higher than ideally desired from the viewpoint of throughput and material reactivity. Residence times for effective mixing and combustion in many existing precalciners 58 are not sufficient to allow for the oxidation of all the carbon in slow burning solid fuels. By increasing the temperature in the precalciner 58 it will also increase the exit temperature and change the location of regions where volatiles condense, often to non-accessible areas.

Stratification of process gas can arise within ducts emerging from a precalciner 58 and in a precalciner 58 itself. Inadequate mixing in a precalciner 58 can lead to an increase in the temperature of the process gas emerging from the precalciner 58 for an apparently unchanged level of calcination of the raw feed. This is the average result from a non-uniform mix of over-calcined and/or under-calcined material that eventually may adversely affect clinkering reactions as well as patterns for deposition of sulphates.

As a result of stratification, attempts to reduce the concentration of nitrogen oxides (“NOx”) via reburning reactions involving fuel injection at suitable process zones may fail to achieve their full potential, again leading to possible undesired and unnecessary emissions. The NOx reburning reaction involves the introduction of fuel and volatiles to a process gas stream deficient in oxygen at a temperature between approximately 1000 to 1400° C. The reaction is more efficient at higher temperatures and lower levels of local stoichiometry.

Another method to reduce NOx is by using a staged combustion. This is achieved by allowing sub-stoichiometric combustion of fuel volatiles, then afterwards introducing the remaining oxygen to complete the combustion, serving to reduce the concentration of NOx formed from the “Fuel NOx” reaction-oxidization of nitrogen in the fuel. Appropriate mixing of the solid and gaseous components in the reaction is advantageous, both before and after staging.

For the further abatement of NOx, a selective non-catalytic reduction (“SNCR”) method can be used with the injection of appropriate amounts of ammonia or ammoniacal compounds (or solutions of these) at a suitable temperature and in the presence of a certain range of oxygen concentration, as this gas is involved in the chemical reaction as set forth:
2NH₃+2NO+0.5O₂←====→2N₂+3H₂O

The active component is the NH₂* radical, which may also be provided by alternative reagents. Theoretically, the optimum temperature range for efficient reduction is between approximately 850 to 1050° C. In practice, it is not always possible to assure suitable complete reaction of the injected ammonia by providing sufficient residence time for the reacting molecules at the appropriate conditions of gas temperature and composition. A consequence will be the emission to atmosphere of undesired traces of ammonia and/or a failure to get the emission level of oxides of nitrogen down to the desired level. The ammonia emission presents a double problem in that it may both infringe operating permits and lead to the formation of a dark-colored plume above the chimney stack. This arises as the emitted gases cool, through formation of a fine fume of ammonium salts (usually sulphate or chloride) that is very effective at scattering light.

It has also been observed that the use of fuels that are difficult to burn in secondary firing systems, such as lump coal, or of fuel that is incompletely burned in the precalciner 58, can be associated with the detection of dioxins and/or furans in dust from an exhaust gas by-pass system, which allows the kiln operator to bleed off a fraction of the exhaust as more fully described above (in which a proportion of the gas stream is extracted, cooled and de-dusted to removed condensed volatile compounds). This is attributed to unburned fuel, such as carbon or volatiles, being carried into the off-take 80 and the exhaust gas by-pass system and acting as drivers for the de novo dioxin synthesis reaction. It is desirable to prevent such carry-over and use the fuel energy productively.

There are a variety of geometrical designs of preheaters 22 (including ducts and cyclones) and precalciners 58 that may be connected to an inclined rotary kiln 42. The use of any specific variant in these descriptions is not intended to limit the embodiment of the invention, but merely to indicate general principles that can be applied to resolving problems in a kiln system. The same is true for the range of fuels that may be used and methods of fuel preparation and delivery to the kiln system. Additionally, although descriptions are generally made on the basis of a symmetrical disposition of equipment, practical difficulties may sometimes prevent this from being achieved at a given location, and in such circumstances appropriate adaptations may be needed. Again, these variations are not intended to limit the scope of the invention.

As will be evident from the following text, it is useful to examine and attempt to overcome some of the problems in conventional kiln systems through fluid dynamics.

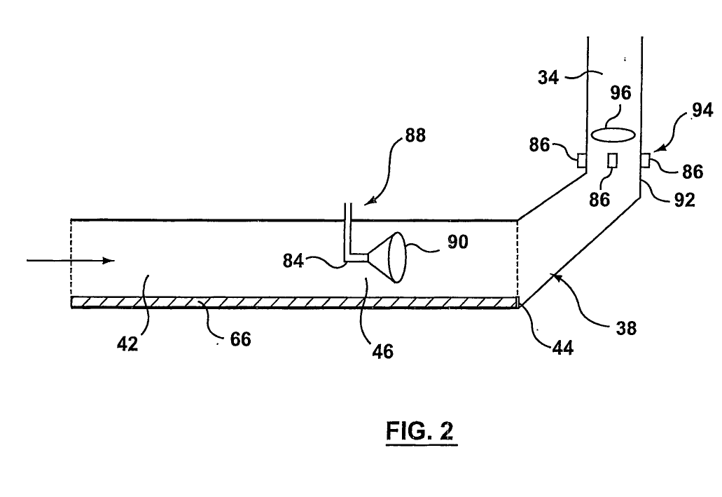

A swirling air system (“SAS”) 82 according to an embodiment of the invention will first be described generally with reference to FIG. 2 and will then be described in more detail. Generally speaking, a SAS 82 according to an embodiment of the invention is a system for injecting gases into the process gas stream at sufficient momentum and turbulence to jet entrain a substantial portion of the process gas stream to provide mixing of the process gas stream and reduce or eliminate stratification within the process gas stream.

As shown in FIG. 2, a SAS 82 may include either a single injector 84 or multiple injectors 86 and may be placed at various locations within the kiln system 20. In a particular embodiment, an injector 84 is placed on the axis of the kiln system, pointing in the direction of process gas flow (an “axial SAS”) 88. The injector 84 is configured to create a swirling vortex 90 within the process gas stream to cause mixing of the process gas stream. In this example, the axial SAS 88 is axially located towards the upper end 46 of the rotary kiln 42, where the gas temperature is approximately 1200° C.

In another embodiment, also shown in FIG. 2, multiple injectors 86 may be positioned around the periphery of a housing 92 of an element of the kiln system 20, for example, the gas riser duct 34, to inject gases across the process gas flow (a “peripheral SAS”) 94. In this case, the injectors 86 can be angled towards a specific central or tangential location, for example, to a 0.3 R (10% area) virtual circle in the center of the process gas flow, to create an initial free vortex 96 that decays with further turbulent mixing to a Rankine vortex. Further, the injectors 86 may be inclined perhaps in the range of 20° to 60° pointing upward in the direction of the process gas flow. This arrangement allows for reburn of NOx or CO to help eliminate or reduce these gases.

In general, an embodiment of the SAS 82 may be placed in many areas of the kiln system 20. For example, in, the gas riser 34, the precalciner 58, the exhaust gas by-pass off-take 80, or the rotary kiln 42. In these cases, the SAS 82 may also be referred to as a “preheater SAS”, “gas riser SAS”, “precalciner SAS” or the like.

Typically the details of each SAS 82 design will be process and plant specific but are preferably based on the rules of fluid dynamics for jet entrainment. Each SAS 82 is designed using jet entrainment equations to generally provide advantages to the particular installation involved. By way of example, in the axial SAS 88, all of the process gas downstream of the axial SAS 88 is generally fully entrained into the jet flow before the new plug flow region. In the peripheral SAS 94, a relative proportion of all the process gas is generally entrained into each jet before their meeting point in the central toroidal vortex 96 for greater mass and heat transfer (e.g., a quarter of the process gas flow for each one of four injectors).

As an example, the fluid dynamics equation used may be:
Mj/Mo[K1 (K2+K3*S)*x]/[do*(Tf/To)^{1/2}]
Where:
Mj, Mo total mass in jet at distance x, initial mass in jet
K1 constant, depending on size of bluff body and degree of cross flow, range 1 to 1.4
K2 constant—0.35 (experimentally derived)
K3 constant—4 (experimentally derived)
S swirl number of the injector
x axial distance
do effective injector diameter
Tf temperature of fluid to be entrained
To temperature of the jet fluid.

The actual design calculation for specific embodiments of the SAS 82 may alternatively be determined using computational fluid dynamics (“CFD”) techniques. However, at the time of writing, CFD is probably only of value for comparing the effects of possible changes to the geometry or operation of an existing system because CFD may not be able to predict or model swirling flows as well as the application of the above equation due to the current inadequacy of turbulence models available for strongly swirling fluid flows.

As described above, the SAS 82 is provided to inject a high momentum, swirling turbulent stream of air (or other gases) into the stratified gas and particle process gas flow at an area having a temperature of approximately 850-1400° C. in a kiln 42, gas riser 34, precalciner 58, or the like, in order to mix the process gas flow, remove the stratification and improve combustion and gas-to-particle heat transfer, making better use of available oxygen. The additional air—usually with a momentum level similar to that of the main process gas flow—arrives via injector(s) 84 or 86, designed specifically for the plant concerned.

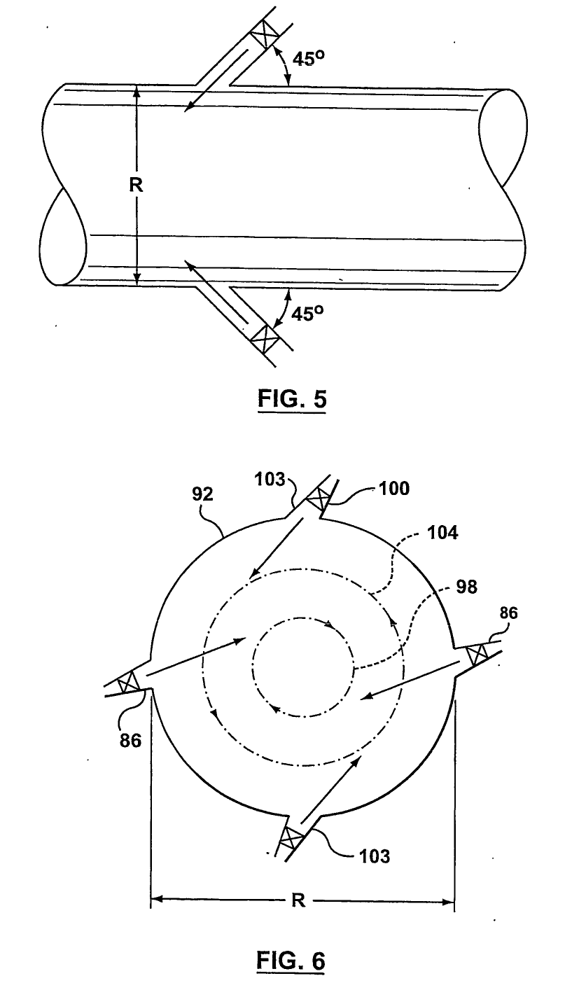

In a preferred embodiment, the injectors 84 and 86 may also be configured to induce swirl or turbulence in the injected gases and thereby enhance entrainment of the process gas flow. FIGS. 4 and 5 show alternative arrangements of the peripheral SAS 94, in which swirl vanes 100 are included within the injectors 84 and 86. The injectors 84 and 86 may also be provided with a bluff body (not shown) or flare diffuser (not shown). A bluff body is a centrally located solid disc or cone near the exit of the injector 84 or 86 of slightly smaller maximum diameter than the injector 84 or 86. The bluff body or flare diffuser additionally enhances jet entrainment.

There are several advantages that may be observed when using a SAS 82 with a typical process gas flow. By way of example, the Reynolds number, which indicates turbulent flow and mixing, is expected to be approximately 2.5 times higher at some 7.5*10⁵ than in a typical main process gas flow, hence increasing turbulent mixing. In addition, the minimum eddy size is expected to be approximately 50 times smaller, that is, less than the size of particles of pulverized coal and raw material (around 3 microns), hence increasing heat transfer for both combustion and calcination. The turbulent frequency, which indicates the rapidity of eddy fluctuations, is also expected to be generally increased by approximately 100 times or more from perhaps 1.5*10⁵ sec⁻¹ to 5*10⁷ sec⁻¹, again facilitating mixing, combustion and heat transfer. Moreover, the jet entrainment and mixing due to the swirl vanes 100 and/or flare diffuser or bluff body is expected to be approximately 2.5 times higher in a specific distance than for injection without such elements at the same velocity, hence the amount of air and fan pressure can be lower for the same effect and give a more beneficial impact on both the installation and the process.

It should be noted that normally, in cement kiln systems, values of Reynolds number, eddy size and turbulent frequency such as the above are found only in the main kiln flame zone.

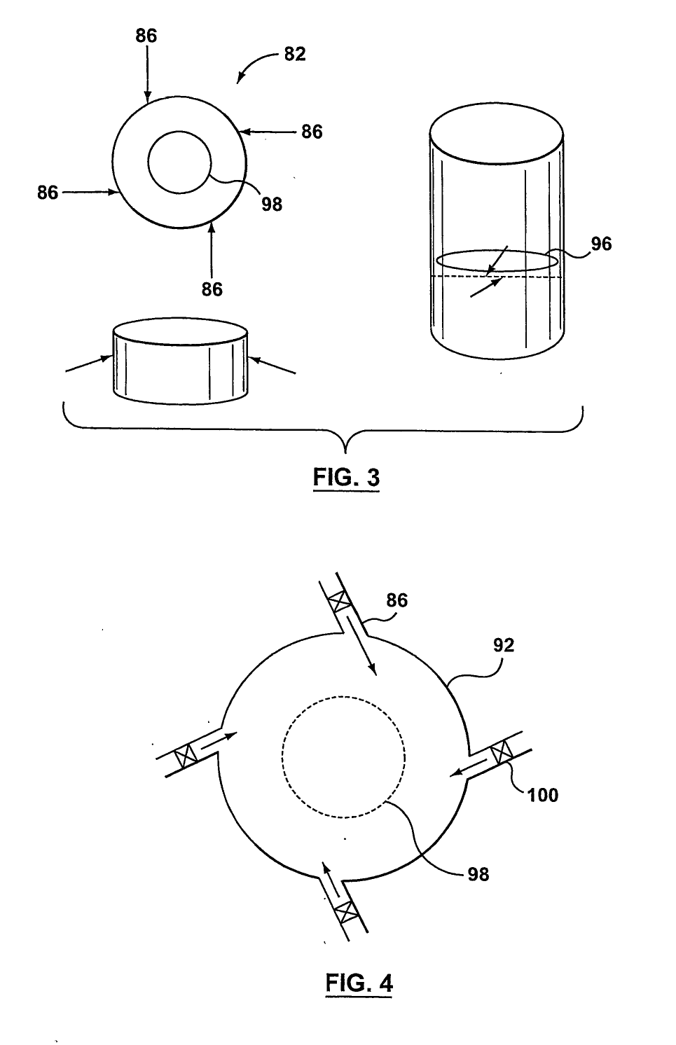

FIG. 3 illustrates the peripheral SAS 94 according to an embodiment of the invention. As described above, the peripheral SAS 94 may be applied to the gas riser 34 duct, the precalciner 58, or to the rotary kiln 42 in the kiln system 20. As shown in FIG. 3, the peripheral SAS 94 includes four injectors 86 directed into and across the process gas stream that is flowing through the gas riser duct 34 or the precalciner 58. In particular, the four injectors 86 are directed tangentially to the 0.3 R circle 98 representing approximately 10% of the area through which the process gas flows (sometimes referred to as a “virtual circle” because it is a targeted area within the process gas flow rather than an element of the kiln system 20).

In this embodiment, gases are injected tangentially at a high momentum level to eliminate the stratification of gases at temperatures ranging between approximately 850 to 1400° C. This embodiment of the invention also improves combustion, other chemical reactions and heat transfer to the solids, such as raw material and raw fuel in the kiln system. An important factor in eliminating gas stratification which can lead to other improvements, is to achieve jet entrainment of the majority of the process gas stream (preferably over 80% and ideally 100%) into a new flow pattern in which turbulence is enhanced and predominates, at temperatures favorable to the chemical reactions. The concept is to create a jet mixed free vortex flow of all the process gases that then decays with further turbulent mixing to an intermediate vortex. The direction of gas injection is preferably neither directly axial nor directly orthogonal to the flow direction of the process gas stream. The gas injection is preferably aimed tangentially from several injectors to one or more virtual circles centrally located within the process gas flow. The virtual circle(s) should cover at least approximately 5% of the cross-sectional area of the process gas flow at the region of injection. The injected gas may be air or oxygenated air, perhaps preheated and optionally directed at an angle of up to approximately 60 degrees to the axial direction of gas flow. Additionally, the gas injection may be carried out via injectors 86 optionally fitted with swirl vanes 100 at approximately 10 to 35 degree angles. Further, bluff bodies or flare diffusers at approximately 5 to 20 degree half angles may also be added to enhance jet entrainment. In a particular case, bluff bodies or flare diffusers may be applied alone (i.e. without swirl vanes), if the swirl vanes at the end of the injector(s) are subject to blockages that may not so severely affect a simpler device.

As will be understood by one of skill in the art, suitable materials for the construction and the protection of the injector(s) 84 and 86 in the kiln system 20 must be considered, for example, steel alloys and/or refractory ceramics that are able to withstand high temperatures are desirable. Internal self-cooling systems (not shown) can also be included.

It may also be advantageous to include suitable mounting systems to facilitate the maintenance and cleaning of the injector(s) 84 and 86 in the kiln system 20. For example, cleaning mechanisms may be added to dislodge any build-up of chemical species, process fume and/or dust that may adhere to a portion of the SAS 82 inside the kiln system 20. Further, where injectors 84 and 86 do not protrude far into the process gas flow and have openings close to the interior lining of the housing, it may be necessary to fit traps for solid particles along with an automatic means of removal of the trapped material.

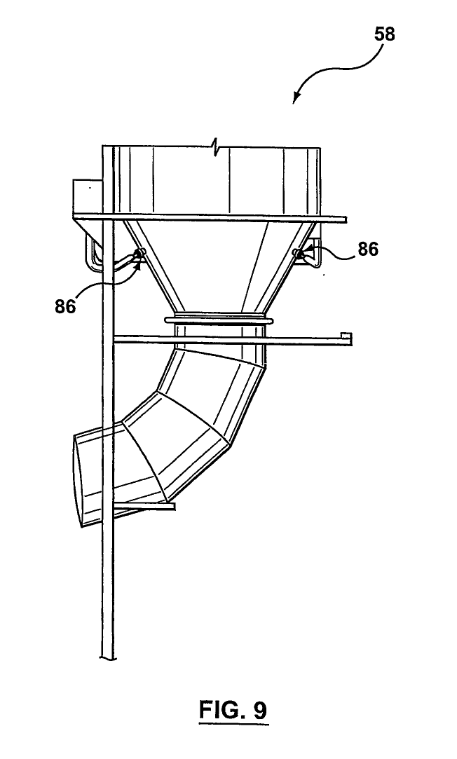

It will also be understood that the SAS 82 will include a gas supply system 102 (see FIG. 8) including a fan or blower (not shown) (i.e. source of air) per injector or one source of air per several injectors. The injected gases are preferably re-used from other parts of the kiln system 20 or other parts of the cement making process, where available.

As a general guide, the gas momentum required for proper mixing of process gases is between approximately 50 and 150 percent (%) of the process gas flow. In order to minimise the amount of excess air injected into the system the velocity should be as high as possible, with a lower limit of approximately 150 m/s and preferably sonic or above. As a general guideline the approximate design criteria for a SAS 82 is a momentum around 10 N/MW and the capability to entrain up to about 15 times the injected jet's own mass before reaching the centre of the process gas stream (for injection at or near the walls of the process vessel) or reaching the walls of the kiln (for injection on or near the axis). This involves a similar level of mixing energy to that used in a high momentum pulverized fuel burner for a kiln or boiler. Preferably, the injection should be at sonic velocity or above, if possible, and will be commensurate to the available fan pressure. A more detailed SAS design is based on the jet entrainment laws for swirling flows and bluff bodies, that take into consideration individual kiln, calciner, preheater, etc. geometries and mass flows and is aimed at achieving complete mixing via entrainment of the relevant process gas stream, before relevant impingement points either with the rotary kiln or other jet streams.

Preferably, directing the injected gases from several points towards the circumference of a virtual circle occupying approximately 10% of the central gas flow area will generally create a central mixing vortex. Adding a weak axial swirl to the injected gases will further enhance mixing, while avoiding the creation of an internal recirculation zone. For the most advantageous effect, the gases should be injected at openings flush with the walls of the kiln system so that they may traverse the maximum possible path length within the process gas stream. Some protrusion of the injectors may, however, be desirable to avoid blockages in situations where solid particles could enter the injectors if they are not kept out by the aerodynamics of the incoming gases or where there are external obstacles that make it impractical to have long straight lengths of injector outside the region of the kiln system concerned.

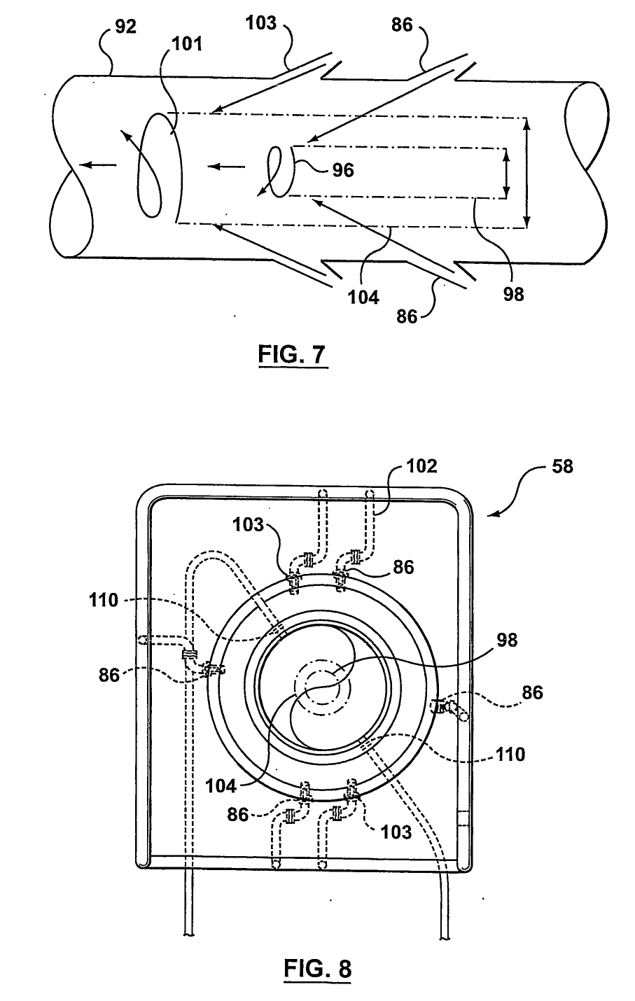

FIGS. 6 and 7 illustrate another embodiment of the peripheral SAS 94. In this embodiment, a first swirl vortex 96 is generated as described above by injectors 86 directed to impinge tangentially on a virtual circle 98 of approximately 0.3 R and is supplemented by a concentric contra-rotating swirl vortex 101, which is created by additional injectors 103 directed tangential to the circumference of a second virtual circle 104 in the process gas stream. In this case, injectors 86 may be aimed at a smaller diameter circle 98 located upstream in the process gas flow, so that an internal vortex 96 can develop prior to penetrating the larger diameter contra-rotating vortex 101 created by additional injectors 103 aimed at the larger virtual circle 104 as it expands to engulf the outer peripheral process gas flow. This will create both intense central mixing and extreme turbulence at the vortex boundaries. As above, swirl vanes 100 may be optionally used in the injectors to create yet further turbulence and bluff bodies or flare diffusers may also be added to further enhance the entrainment.

FIGS. 8 and 9 illustrate a peripheral SAS 94 according to this embodiment of the invention. FIG. 7 illustrates a cross-sectional view of a portion of a precalciner 58, forming part of a kiln system 20. In this case, the precalciner 58 has a housing 92 that is circular in shape and tapers inwardly at its lower end. The precalciner 58 includes two coal lines 110 for feeding fuel into the housing 92. The peripheral SAS 94 is provided to the housing 92 and includes a set of four injectors 86 directed tangential to a virtual circle 98 located at the center of the precalciner 58 and covering approximately 10% of the area of the process gas flow. These injectors 86 induce rotational motion of the process gas flow traveling through the precalciner 58. The peripheral SAS 94 further includes a set of two injectors 103 directed tangentially at a second virtual circle 104 at the center of the precalciner 58 that is approximately twice the area of the first virtual circle 98. In a preferred case, injectors 103 are offset axially along the direction of process gas flow by a distance of approximately one precalciner radius from the first virtual circle 98. These injectors 103 are arranged to induce contra-rotating swirling of the process gas flow to the swirling produced by the set of four injectors 86. The peripheral SAS 94 further includes a gas supply system 102 for delivering injection gas to the injectors 86 and 103.

FIG. 9 shows an elevation of the precalciner 58 showing that the injectors 86 are directed at an upward angle of approximately 30° in this particular embodiment.

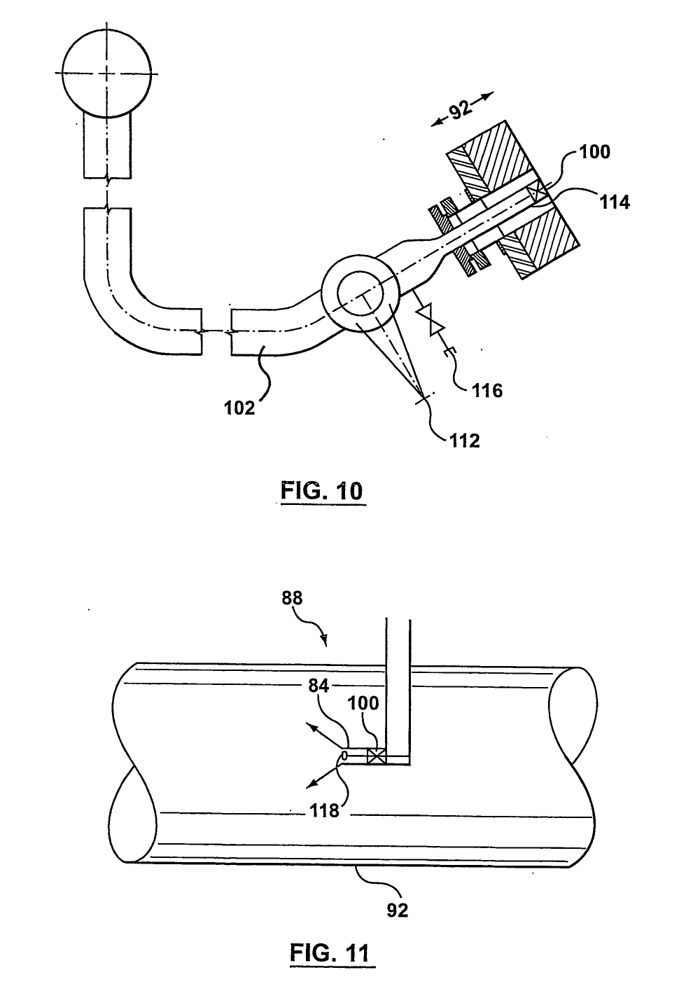

FIG. 10 illustrates an injector 86 of the type included in the SAS 82. The injector includes a valve 112, a pressure sensor (not shown—preferably installed in the injector assembly, just outside the wall of the precalciner vessel) and a nozzle 114, which extends through the housing 92. In particular, there may be some benefit from having the nozzle outlet flush with the inside of the housing wall. The injector 86 may also include an inlet 116 for compressed air to purge the injector 86 of any potential blockage or the like. As discussed above, depending on the embodiment and the type of kiln system, the injector 86 may also be provided with swirl vanes 100 or, optionally, a bluff body (not shown) or flare diffuser (not shown) to further enhance the entrainment.

By way of exemplifying the principles involved, consider the set of chemical reactions involved in NOx reburning where a preheater of a kiln system 20 with a 2000 tonne per day rating has NOx emission from the rotary kiln 42 to the preheater section 22 of 1200 ppm. If the stack emission from the kiln system 20 is to be below 500 mg/Nm3 (corrected to a 10% oxygen concentration, dry basis), part of the solution is to reduce the kiln generated NOx significantly. In this example 20% secondary fuel is added to the process gas stream that has emerged from a primary flame operating at 10% excess air level. The resulting stoichiometry will be 0.85, which is close to the optimum level of 0.88 for NOx reduction in a 0.5 second residence time at a temperature of approximately 1200° C. or more preferably 1300 to 1400° C. To ensure intimate contact of the chemical species involved after the reburning reaction, the SAS 82 can inject air to bring the stoichiometry up to 110% and ensure effective oxidation of carbon monoxide and residual hydrocarbons.

The process gas flow rate for approximately 10% excess air can be calculated from the fuel consumption and carbon dioxide loss from the calcined raw fuel. The process gas velocity at a given temperature can then be assessed for a given duct diameter giving its momentum. If this is used as the target total SAS momentum, a minimum required injection velocity can be assessed from the additional air quantity needed to reach the 15% overall excess air supply if an injected air temperature of 20° C. is assumed.

FIG. 11 shows the axial SAS 88 in more detail. The axial SAS 88 is useful to avoid possible problems with blockage of injectors located flush with the internal lining of the rotary kiln (i.e. like those in a peripheral SAS 94) because the axial SAS 88 involves an injector 84 which is placed centrally in the rotary kiln 42 and is directed in the same direction as the process gas flow (opposite in direction to the raw meal). In this case, the injector 84 is preferably provided with 30° swirl vanes 100 and may also include a bluff body or flare diffuser (as discussed above) and the injected air is provided with enough momentum to entrain the process gas flow as much as possible before the impingement point at the kiln wall. This helps to ensure that the carbon in the process gas flow is burned out and allows avoidance of high sulphate-based build up in the kiln system 20. As shown in FIG. 11, the injector 84 may also be provided with a cleaning device 118 to remove any deposit build-up that may block the injector 84.

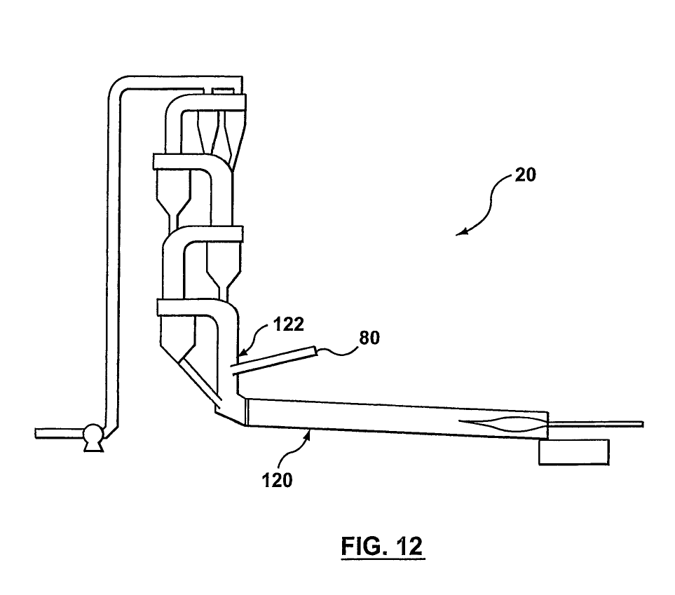

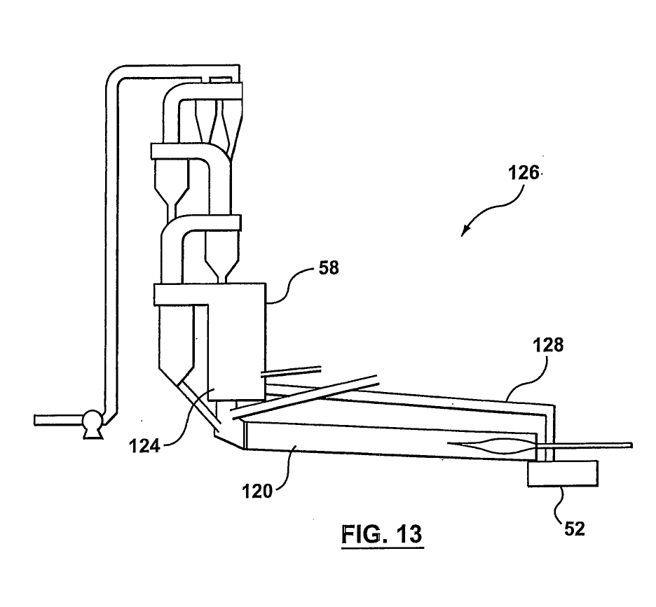

FIG. 12 illustrates the location of a kiln SAS 120 or gas riser SAS 122 (both of which may be an axial SAS or a peripheral SAS) in relation to the overall structure of a preheater kiln system 20. In some cases, it may be useful to have the SAS 82 in both the rotary kiln 42 and in the gas riser 34, for example, when trying to use whole used tires in a reburn reaction, a kiln SAS 120 can help avoid build-up problems and a gas riser SAS 122 can help bring in the extra air to avoid CO formation. If the SAS 82 is applied to the rotary kiln 42 it is preferably placed in an area where the gas temperature is approximately 1200° C.

FIG. 13 illustrates the location of a kiln SAS 120 or calciner SAS 124 in relation to the overall structure of an air separate precalciner kiln system 126. In FIG. 13, the kiln system 126 includes a tertiary air duct 128 which takes heated air from the clinker cooler 52 to the precalciner 58 and thus is referred to as an air-separate precalciner kiln system 126.

The SAS 82 is intended to assist in overcoming typical combustion-related difficulties. Generally, these include reducing the impact of lump fuel on sulphate-based build-up in gas riser ducts 34, facilitating the use of petcoke with alternative fuels such as tyres or other lump fuels, reducing the level of CO and temperature produced at the exit of gas risers and calciners when both conventional and alternative fuels are used, reducing NOx, via reburning and/or staged combustion, reducing ammonia “slip” in the SNCR de-NOx procedure, and reducing the amount of trace dioxins or furans formed in an exhaust gas by-pass system (although not all benefits will necessarily be present at the same time). By way of example, some of the benefits may be an increased use of more (or coarser) alternative fuels and/or an increased use of alternative fuels at the same time as petroleum coke. The use of the SAS 82 is also intended to contribute to resultant benefits such as the substitution of more coal or oil by petcoke, the lowing of CO emissions with the use of alternative fuels and lower NOx emissions. The above intended benefits may be achieved while attaining the goals of a higher clinker output rate and the increased burn-out of fuel traces arriving with raw materials.

The installation of a kiln SAS 120, with an appropriate momentum, angle of swirl vanes 100, bluff body size or flare diffuser so that a significant portion of the process gas flow is entrained into the swirling flow, before the beginning of a new plug flow zone in the rotary kiln 42 at approximately the end of the calcination zone (gas temperature >1200° C.), is expected to promote the combustion of the unburned fuel in the process gas flow. The kiln SAS 120 is expected to facilitate combustion in the process gas flow by making the O₂ concentration more uniform within the portion of the kiln system that it is added to. In addition, the kiln SAS 120 should facilitate the scrubbing away of the CO₂ layer that forms over the hot meal in the inclined rotary kiln 42. In exposing the unburned fuel more often to a higher O₂ concentration and by stirring up the feed bed, combustion should be increased overall in the kiln system 20. (Although there may be practical limits as to just how much dust recirculation can be tolerated).

By increasing the combustion in the process gas flow, it should facilitate such things as the use of lower levels of O₂ at the upper end 46 of the rotary kiln 42 for the same level of substitution of conventional fuel by lump fuel. This in turn should result in less impact on the clinker output rate. In addition, it should facilitate the use of higher and/or coarser levels of lump fuel for the same level of O₂ at the upper end 46 of the rotary kiln 42.

The installation of a kiln SAS 120 is also expected to facilitate the use of petcoke with alternative fuels. The advantage in using the SAS 82 is that the use of lump fuel with petcoke generally produces a more severe build-up of sulphates, for the reasons described above, at even modest levels of petcoke use. Therefore, the installation of a SAS 82 in the kiln system at the end of the calcination zone should facilitate the use of higher levels of petcoke and/or a higher S grade of petcoke.

The installation of a gas riser SAS 122 or precalciner SAS 124 is expected to reduce the exit CO and temperature level from gas riser ducts 34 and precalciners 58 with alternative fuel usage. Due to higher volatile release rates from alternative fuels and the stratification of the O₂ supply from the kiln and the exhaust gas by-pass system, which in turn leaves insufficient O₂ available locally to combust the volatiles, in an excess of O₂, to produce sufficient OH radicals to facilitate CO burnout; the introduction of lump fuel alone (indeed, this also happens with pulverized coal to a certain extent) to gas risers and calciners may produce increases in CO and exit temperatures. This leads to the need for higher riser duct 34 or precalciner 58 O₂ levels, leading to increases in fuel consumption and decreases in clinker output rate. Therefore, the installation of a SAS 82 in a precalciner 58 that is designed for the appropriate momentum, angle of swirl vane 100 and/or bluff body size or flare diffuser to mix as much as possible of the gas riser duct or precalciner flow into the high momentum swirling flow(s) before the centre point of the duct is expected to reduce stratification and CO, the O₂ level needed to eliminate CO and exit temperatures. In turn, the addition of a SAS 82 should also result in a better burnout of coal, petcoke or lump fuel improving fuel consumption and the clinker output rate by increasing the calcination rate via the removal of the CO₂ boundary layer.

The installation of a SAS 82 is further expected to reduce NOx, via reburning and staging. Introducing volatiles into the process gas flow at approximately 1000-1400° C. should reduce NOx via the reburning reaction, providing there is a deficiency of O₂. The efficiency of the reburning depends on the temperature (the higher the better, 1200° C. being a good level) and the local stoichiometry (0.85 is preferable). In addition, the staging of combustion, by allowing the coal volatiles to burn sub-stoichiometrically and re-introducing the remainder of the air afterwards, reduces NOx formation from oxidation of the nitrogen in the fuel. Therefore, both reburning and staging can be used in the cement making process to reduce NOx levels and even produce “Low NOx” cement kiln systems.

The SAS 82 can make the strategy more effective since it may facilitate the burn out of char after the final exhaust gas by-pass system introduction if a precalciner SAS 124 is added to the kiln system. Where a kiln SAS 120 variant is added it will also increase the effectiveness of the strategy by ensuring that, if lump fuel is used for reburning, it is burnt out before the end of the calcination zone. In addition, the use of the kiln SAS 120 to facilitate fuel burn-out, will also help the reburning by producing a more uniform concentration of O₂ at the upper end of the kiln 46.

By installing a SAS 82 downstream in the process gas flow from the injection point of ammonia in a plant operating the SNCR de-NOx procedure, the small amount of unreacted or “slipped” ammonia can be converted to NO, hence avoiding the dark plume formation and ammonia emission problems and allowing more ammonia to be added for a better degree of NOx reduction.

In addition to all of the advantages listed above, the installation of a SAS 82 is also expected to reduce dioxins from an exhaust gas by-pass system. It has been observed that when lump fuel is fed into the kiln feed shelf 38 or into the precalciner 58, the resulting poor burnout can lead to dioxins being formed in by-passes. This has also been observed where coal is used as a fuel. The potential for dioxin formation is due to unburned carbon or volatiles being carried up the off-take 80 of an exhaust gas by-pass system and acting as drivers for a de novo synthesis reaction. Therefore, the installation of a SAS 82 in the early part of the by-pass (in a similar manner to a calciner or gas riser) should facilitate the burn out of the unburned material and eliminate dioxin formation.

The installation of a SAS 82 may also improve the clinker output in a kiln system 20. The general use of the range of SAS 82 facilitates a lower O₂ level within the kiln system 20; lower exit gas temperatures, better combustion and better heat transfer to the solid material being processed. Hence, as an alternative to taking up all of these advantages to their fullest extent (exploiting greater levels of fossil fuel substitution by alternative fuels or petcoke or seeking lower NOx levels), an increase in clinker output rate can be obtained.

In the above text, although “fuel” has been discussed, it will be understood that combustible material, char or volatile, can also arrive with raw materials. Either char may survive passage through the preheater, or material with a volatile fuel content may be fed to a lower stage of a preheater 20 or possibly to the precalciner 58 in order to reduce episodes of volatile distillation and emission to air, that might occur if such material were added nearer to the preheater gas exit.

Further, although the above embodiments discuss the injection of air or gas, steam could, in principle, be injected instead of or as well as air (although requiring more momentum to achieve the same mixing effect), if conveniently available under pressure. As will be understood, steam alone will not provide the same levels of oxygen, however, this may not be important in situations where producing the mixing effect may be the more important feature of the SAS 82.

It will be further understood that the invention is not limited to the embodiments described herein which are merely illustrative of preferred embodiments of carrying out the invention, and which are susceptible to modification of form, arrangement of parts, steps, details and order of operation. The invention, rather, is intended to encompass all such modification within its scope, as defined by the claims, including application to kiln systems producing products other than Portland cement clinker. Further, the invention is not limited to the use of a SAS 82 at only one point in a kiln system and circumstances may exist where a second (or more) SAS 82 system will add to the advantages and/or produce different advantages.

### EXAMPLE

A SAS system as described above has been successfully applied in a 4500 tpd off line calciner kiln system. The kiln was 84 m long and 5.2 m in diameter; the calciner had a volume of 350 m³ with a gas residence time of 2.5-3.0 secs.

Without the SAS, even at high oxygen levels that cause a drop in output rate, the calciner had significant CO problems, resulting in levels of up to 1500 ppm CO at the stack (corresponding to 10,000 ppm ex calciner at normal O2 levels of 2-3%). The high CO was thought to come from poor mixing, hence SAS was tried as a solution to the problem.

SAS was installed with a 10,000 Nm³/hr fan, which could supply at 2500 mm water gauge with the aim of resolving problems of CO generation due to poor mixing conditions. The system had 4 swirler flow injectors with 20 degree swirl vanes injecting on to a circle of 0.3 R radius (R=calciner duct radius) and 2 swirler flow injectors directed on to a 0.5 R circle (in the same plane) in a counter rotating manner, generally as illustrated in this text.

A significant reduction in CO level of some 2500 ppm was achieved at the calciner and around 500 ppm at the stack, coupled with a drop in the concentration of NOx. Analysis of the carbon content in the hot meal feed to the kiln and the drop in CO indicated that a fuel saving of 1.5% was achieved. Analysis of the hot meal indicated a drop in LOI (loss on ignition) of 2 indicating better decarbonation of the feed %, which will allow an increase in output from the kiln. It was not possible to reduce the CO level to zero, due to the instability of the coal feed at the time of the measurements, as during some periods there was insufficient oxygen to burn the excess coal delivered transiently.

It was further realized that there should not be any significant imbalance in the construction or performance of any injectors (when there is more than one of them). Differences in fabrication and significant differences in the layout of ducts connecting the fan(s) may resulted in different performance from each injector.

1. A system for mixing a process gas flow that is flowing through a housing (92) of a kiln system (20), said system comprising:
at least one injector (84,86) provided to said housing (92);
a gas supply system (102) connected to said at least one injector (84,86) for supplying injection gas to said injector (84,86) at a predetermined pressure; and
wherein said injector (84,86) and said predetermined pressure are arranged and selected to inject said injection gas into the housing (92) at sufficiently high momentum to produce a jet having appropriate turbulent flow characteristics such that the process gas flow is entrained by said injected gas; and
wherein said injector (84,86) is provided with swirling means for providing axial swirl to said injected gas.

2. A system according to claim 1, wherein the injector is arranged so that the gas flow is flowing through a housing (92) along an axis of said housing (92).

3. A system according to claim 1, wherein said swirling means comprises swirl vanes (100).

4. A system according to claim 3, wherein said swirl vanes (100) have an angle of approximately 10 to 35 degrees.

5. A system according to claim 1, wherein said injector (84,86) is provided with flare diffusers to enhance said entrainment.

6. A system according to claim 1, wherein said injector is provided with a bluff body to enhance said entrainment.

7. A system according to claim 1, wherein said injector is provided with a bluff body and flare diffusers to enhance said entrainment.

8. A system according to claim 5, wherein said flare diffusers are at approximately 5 to 20 degree half angles.

9. A system according to claim 1, wherein said process gas flow is substantially entrained before the injected gas flow is converted to plug flow along with the process gas flow or before the injected gas flow impinges upon an interior of the housing (92).

10. A system according to claim 1, said system comprising:
a plurality of injectors (84,86) provided to said housing (92) and arranged at predetermined intervals around a cross section of said process gas flow and in communication with an interior of said housing (92); and
a gas supply system (102) for supplying injection gas to said injectors at a predetermined pressure,
wherein said injectors (84,86) are directed to inject said injection gas to impinge tangentially on a circle (98) centered on an axis of said process gas flow and covering at least approximately 5 to 15 percent of a cross sectional area of said process gas flow.

11. A system according to claim 10, wherein said plurality of injectors (84,86) and said predetermined pressure are arranged and selected to inject said injection gas into the housing (92) at sufficiently high momentum to produce a jet having appropriate turbulent flow characteristics such that the process gas flow is entrained by the injected gas.

12. A system according to claim 11, wherein said process gas flow is substantially entrained before the injected gas flow is converted to plug flow along with the process gas flow or before the injected gas flow impinges upon an interior of the housing (92).

13. A system according to claim 10, wherein said circle (98) covers at least approximately 5 percent of the cross sectional area of said housing (92).

14. A system according to claim 10, wherein said circle (98) covers approximately 10 percent of the cross sectional area of said housing (92).

15. A system according to claim 10, wherein said swirling means comprises swirl vanes (100).

16. A system according to claim 15, wherein said swirl vanes (100) have an angle of approximately 10 to 35 degrees.

17. A system according to claim 10, wherein said injectors (84,86) are provided with flare diffusers.

18. A system according to claim 10, wherein said injectors (84,86) are provided with bluff bodies.

19. A system according to claim 10, wherein said injectors (84,86) are provided with bluff bodies and flare diffusers.

20. A system according to claim 17, wherein said flare diffusers are at approximately 5 to 20 degree half angles.

21. A system according to claim 10, wherein said plurality of injectors (86) are directed at an angle of approximately 0 to 60 degrees in the direction of process gas flow.

22. A system according to claim 21, wherein said plurality of injectors (86) are directed at an angle of approximately 25 to 40 degrees in the direction of process gas flow.

23. A system according to claim 10, wherein said plurality of injectors (86) comprise a first set of injectors (86) and said system further comprises a second set of injectors (103) comprising:
at least one injector (103) provided to said housing, arranged at a second cross section of said housing (92) and in communication with an interior of said housing (92), and
a second gas supply system for supplying injection gas to said at least one injector (103) at a predetermined pressure,
wherein said at least one injector (103) is directed to inject gas to impinge tangentially on a second circle (104) centered on an axis of said housing (92) that has a different diameter than the circle (98) of said first set (86) of injectors.

24. A system according to claim 23, wherein said second circle (104) has a larger diameter than said circle (98).

25. A system according to claim 23, wherein said second cross section of said housing (92) is spaced apart from said cross section of said first set of injectors (86) in the direction of process gas flow.

26. A system according to claim 23, wherein said gas supply system (102) for said first set of injectors further comprises said second gas supply system.

27. A system according to claim 1, wherein said injected gas is air or oxygenated air.

28. A system according to claim 1, wherein said injected gas is preheated.

29. A system according to claim 1, wherein said kiln system (20) is for preparing cement clinker and said system is in a region of said kiln system (20) where gas temperature is between approximately 850 to 1400 degrees Celsius.

30. A system according to claim 29, wherein said gas temperature is between approximately 1000 to 1250 degrees Celsius.

31. A system according to claim 1, wherein said housing (92) is a housing of a rotary kiln (42).

32. A system according to claim 1, wherein said housing (92) is a housing of an exhaust gas by-pass system.

33. A system according to claim 1, wherein said housing (92) is a housing of a precalciner.

34. A system according to claim 1, wherein said housing (92) is a housing of a gas riser duct (34).

35. A system according to claim 1, wherein said housing (92) is a housing of a precalciner in a region near a gas exit where gas temperature is between approximately 900 to 1250 degrees Celsius.

36. A system according to claim 1, wherein said housing (92) is a housing of said kiln system (20) in a region in which said system will enhance efficiency and completion of reactions with ammonia where gas temperature is between approximately 850 to 1050 degrees Celsius.

37. A method of mixing a process gas flow of a kiln system comprising:
providing a source of injection gas at high pressure; and
injecting said injection gas into said process gas flow via at least one injector at sufficiently high momentum to produce a jet having appropriate turbulent flow characteristics such that the process gas flow is entrained by the injected gas;
further comprising imparting swirl to said injected gas as it enters a housing of the kiln system (20).

38. A method of mixing a process gas flow according to claim 37, wherein said swirl is imparted by swirl vanes provided to said at least one injector.

39. A method of mixing a process gas flow according to claim 37, wherein said entrainment is further enhanced by a bluff body provided to said at least one injector.

40. A method of mixing a process gas flow according to claim 37, wherein said entrainment is further enhanced by a flare diffuser provided to said at least one injector.

41. A system according to claim 37, wherein said entrainment is further enhanced by a bluff body and a flare diffuser provided to said at least one injector.

42. A method of mixing a process gas flow according to claim 37, wherein a total momentum of said injected gas during injection is approximately 50 to 150% of a momentum of said process gas flow.

43. A method of mixing a process gas flow according to claim 37, wherein said injected gas is injected at or above approximately 150 meters/second.

44. A method of mixing a process gas flow in a housing of a kiln system comprising:
providing a source of injection gas at high pressure; and
injecting said injection gas into said housing via at least one injector such that said injection gas impinges tangentially on a circle centered on an axis of said process gas flow and covering at least approximately 5 to 15 percent of a cross sectional area of said process gas flow.

45. A method of mixing a process gas flow according to claim 44, wherein said injecting of said injection gas into said process gas flow is at sufficiently high momentum to produce a jet having appropriate turbulent flow characteristics such that the process gas flow is entrained by the injected gas.

46. A method of mixing a process gas flow according to claim 44, further comprising imparting swirl to said injection gas as it enters the housing.

47. A method of mixing a process gas flow according to claim 45, wherein said swirl is imparted by swirl vanes provided to said at least one injector.

48. A method of mixing a process gas flow according to claim 45, wherein said entrainment is further enhanced by a bluff body provided to said at least one injector.

49. A method of mixing a process gas flow according to claim 45, wherein said entrainment is further enhanced by a flare diffuser provided to said at least one injector.

50. A method of mixing a process gas flow according to claim 45, wherein said entrainment is further enhanced by a bluff body and a flare diffuser provided to said at least one injector.

51. A method of mixing a process gas flow according to claim 45, wherein a total momentum of said injection gas during injection is approximately 50 to 150% of a momentum of said process gas flow.

52. A method of mixing a process gas flow according to claim 44, wherein said injection gas is injected at or above approximately 150 meters/second.

53. A method of mixing a process gas flow of a kiln system according to claim 44, wherein the Reynolds Number due to said mixing is approximately 2.5 times above that encountered in a typical process gas flow without said mixing.

54. A method of mixing a process gas flow of a kiln system according to claim 44, wherein the turbulent frequency due to said mixing is approximately 100 times above that encountered in a typical process gas flow without mixing.

55. A method of mixing a process gas flow of a kiln system according to claim 44, wherein a total momentum, turbulence and swirl of said injected gas are selected based on aerodynamic calculation such that said injected gas will substantially entrain the whole of said process gas flow before the injected gas flow is converted to plug flow along with the process gas flow or before the injected gas flow impinges upon an interior of the housing.

56. A method of mixing a process gas flow of a kiln system according to claim 44, wherein a total momentum, turbulence and swirl of said injected gas, are selected based on mathematical modelling such that said injected gas will substantially entrain the whole of said process gas flow before the injected gas flow is converted to plug flow along with the process gas flow or before the injected gas flow impinges upon an interior of the housing.

57. A rotary kiln of a kiln system provided with a system for mixing a process gas flow according to claim 1.

58. A precalciner of a kiln system provided with a system for mixing a process gas flow according to claim 1.

59. An exhaust gas by-pass system of a kiln system provided with a system for mixing a process gas flow according to claim 1.

60. A preheater section of a kiln system provided with a system for mixing a process gas flow according to claim 1.

61. A gas riser duct of a kiln system provided with a system for mixing a process gas flow according to claim 1.
